(19) United States
(12) Patent Application Publication
(10) Pub. No.: US 2007/0204736 A1
(43) Pub. Date: Sep. 6, 2007

(54) Connector pins cutting machine

(76) Inventors: Gao-Hua Yu, Tucheng City (TW); Sheng Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/367,488

(22) Filed: Mar. 6, 2006

(51) Int. Cl. B26D 1/04

(52) U.S. Cl. 83/613; 83/929.2

(57) ABSTRACT

A connector pins cutting machine for cutting soldering portions of idle pins of a connector includes a base member, a containing member mounted on the base member having at least one sliding groove extending there-through, a connector positioning member coupled to the containing member having at least one connector-positioning recess for positioning the connector with the soldering portions of the idle pins extending into the sliding groove, a propeller slidably contained in the sliding groove, a cutting member installed on a front end of the propeller, and a driving member fixed to a rear end of the propeller for driving the propeller together with the cutting member to reciprocate in the sliding groove. Thereby, the soldering portions in the sliding groove are cut by the cutting member.

### BACKGROUND OF THE INVENTION

1. Field of the Invention

The present invention relates to a machine for processing electrical connectors, and more particularly, to a machine for cutting pins of the electrical connectors.

2. The Related Art

We know existing connectors for cables are mostly constructed from insulating housings and multiple conductive connector pins. The connector pins are used for transmitting electric power or signals. The insulating housing holds these conductive pins therein for insulating these pins from outside and simultaneously to avoid these pins being into contact with each other. Each pin has a soldering portion for being soldered with one according electric wire of the cable. For conforming with technical standards governing dimensional configuration and electrical characteristics, the housings of the existing connectors often have been available in various designate size and shapes, and a lot of connector pins are commonly disposed in one housing. However, some of these connector pins are functional pins which need to be soldered with the wires of the cable so as to transmit electric power or signals, others of these connector pins are idle pins which have no actual use and need not to be soldered with the wires of the cable. Therefore, for decreasing the possibility of unexpected contacts generated between the adjacent soldering portions or generated between the soldering portions of the idle pins and the electric wires of the cable, it is suggested to cut the soldering portions of these idle pins.

However, in prior art, the soldering portions of these idle pins are often cut by pliers by manual manipulation, the cutting force acted on the pins and the cutting dimensions of the pins are more difficult to control, thereby there may be a high unqualified rate of the products in this producing manner. Furthermore, more manual labor is needed in producing, which increase the producing cost so that cannot be applied in mass production of the connectors.

### SUMMARY OF THE INVENTION

Accordingly, an object of present invention is to provide a connector pins cutting machine which can provide a high qualified rate in production of the connectors.

Another object of present invention is to provide a connector pins cutting machine which is applied in mass production of the connectors.

To achieve the above objects, a connector pins cutting machine is provided, which is used for cutting soldering portions of idle pins of a connector. The connector pins cutting machine includes a base member, a containing member mounted on the base member having at least one sliding groove extending there-through, a connector-positioning member coupled to the containing member, the connector-positioning member having at least one connector-positioning recess opening upward and communicating with the sliding groove for positioning the connector with the soldering portions of the idle pins extending into the sliding groove, a propeller slidably contained in the sliding groove, a cutting member installed on a front end of the propeller, and a driving member fixed to a rear end of the propeller for driving the propeller together with the cutting member to reciprocate in the sliding groove. Thereby, the soldering portions in the sliding groove are cut by the cutting member.

Constructed as mentioned-above, the connector pins cutting machine can provides predetermined and constant cutting force and cutting dimensions to the pins, thereby decreasing the unqualified rate of the connectors. Furthermore, the connector pins cutting machine is driven by special driving member, so less manual labor is needed, thereby the connector pins cutting machine is adapted to be applied in mass production of connectors.

These and other features, objects and advantages of the present invention will be more fully apparent from the following detailed description set forth below when taken in conjunction with the accompanying drawings.

### BRIEF DESCRIPTION OF THE DRAWINGS

FIG. 1 is a perspective view of a connector pins cutting machine according to the present invention;

FIG. 2 is an exploded view of a cutting system of the connector pins cutting machine in FIG. 1;

FIG. 3 is a perspective view of a containing member of the connector pins cutting machine in FIG. 2;

FIG. 4 is a perspective view of a connector-positioning member of the connector pins cutting machine in FIG. 2;

FIG. 5 is a perspective view of a driving member of the connector pins cutting machine in FIG. 2;

FIG. 6 is a perspective view of a propeller of the connector pins cutting machine in FIG. 2;

FIG. 7 is a perspective view of a cutting member of the connector pins cutting machine in FIG. 2;

FIG. 8 is an assembled perspective view of the cutting system of the connector pins cutting machine in FIG. 2;

FIG. 9 is a perspective view of a pre-cutting connector; and

FIG. 10 is a perspective view of the connector with some pins thereof cut.

### DETAILED DESCRIPTION OF THE PREFERRED EMBODIMENT

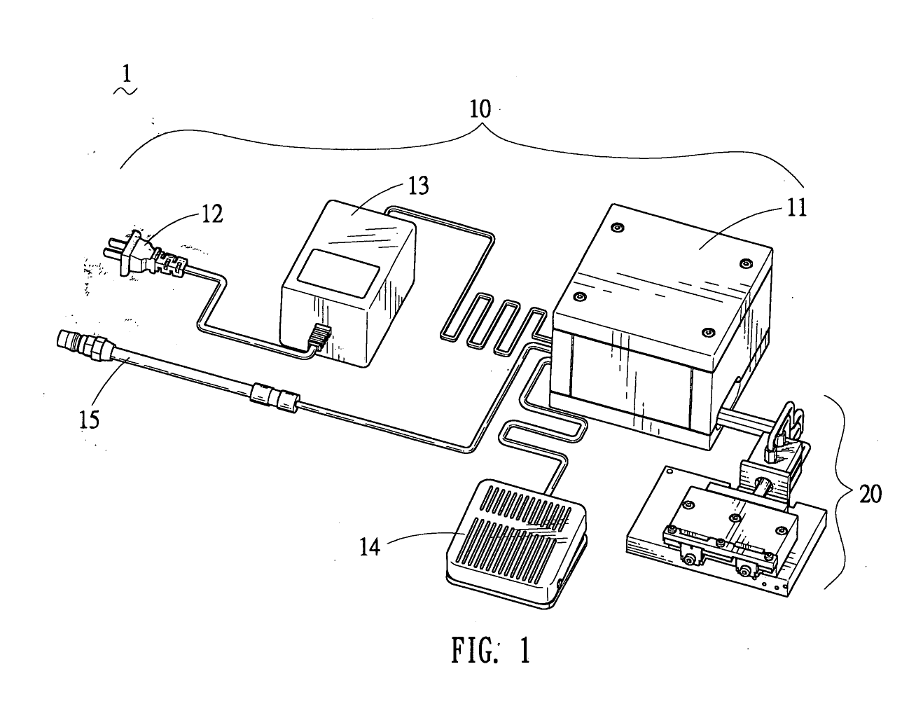

With reference to FIG. 1, a connector pins cutting machine 1 according to the present invention is illustrated, which includes a cutting system 20 and a power supply system 10 for supplying driving power to the cutting system 20. The power supply system 10 includes a high pressure air feeding pipe 15 for providing high pressure air, a relay device 11 connected with the air feeding pipe 15 for controlling how the high pressure air will be fed to the cutting system 20, a power plug 12 for obtaining original electric power from a power source, a transformer 13 connected between the power plug 12 and the relay device 11 for transforming the original electric power to a proper voltage electric power matching with the relay device 11, and a switch 14 connected with the relay device 11 for switching the relay device 11 on and off.

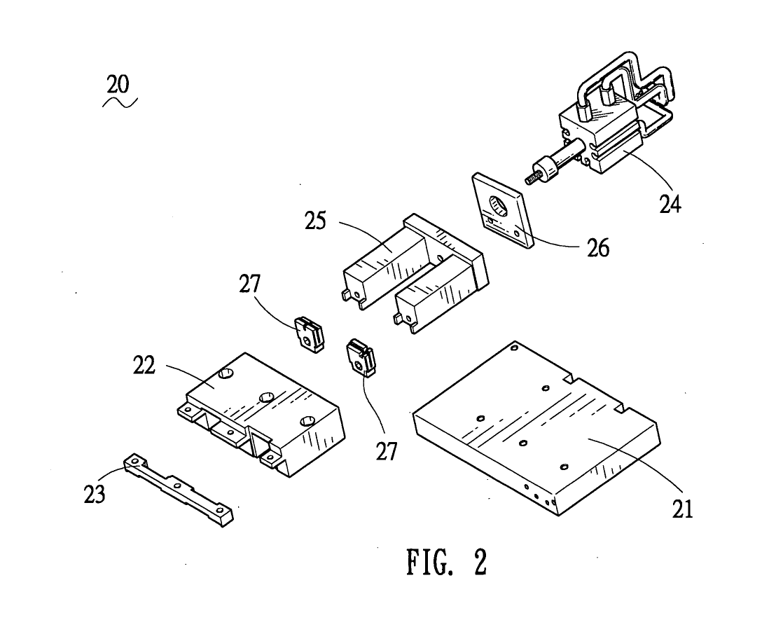

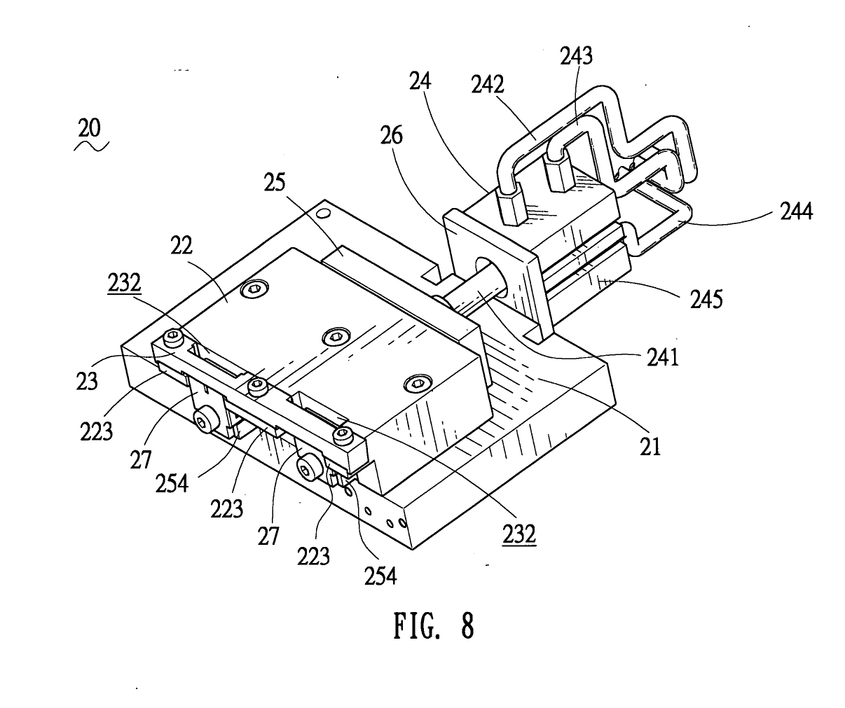

Please refer to FIG. 2 in conjunction with FIG. 8. The cutting system 20 includes a base member 21, a containing member 22 mounted on the base member 21, a connector-positioning member 23 coupled to the front of the containing member 22, a propeller 25 slidably retained in the containing member 22, two cutting members 27 installed on the front of the propeller 25, and a driving member 24 fixed to the end of the propeller 25.

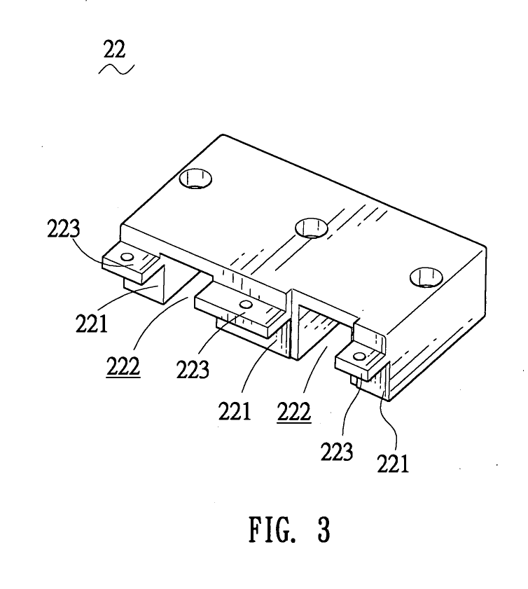

With reference to FIG. 3, the containing member 22 has three parallel supporters 221 for supporting the containing member 22 on the base member 21 and two parallel sliding grooves 222 consequently defined between the three supporters 221. The two sliding grooves 222 extend through the containing member 22 front to rear. The front end of each supporter 221 provides a locking bar 223.

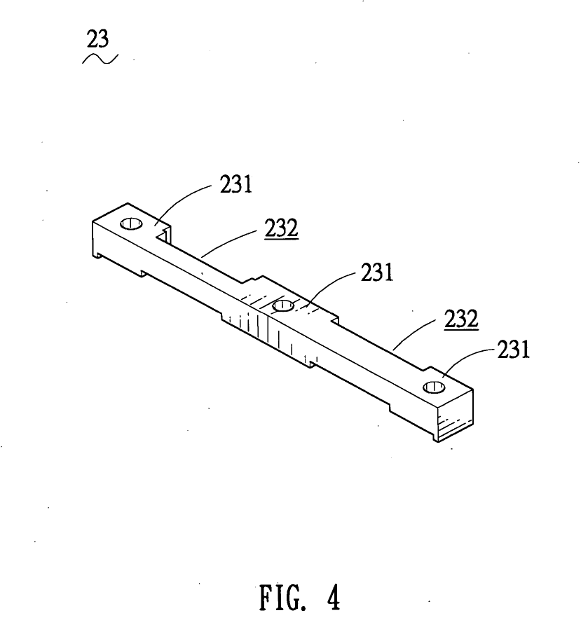

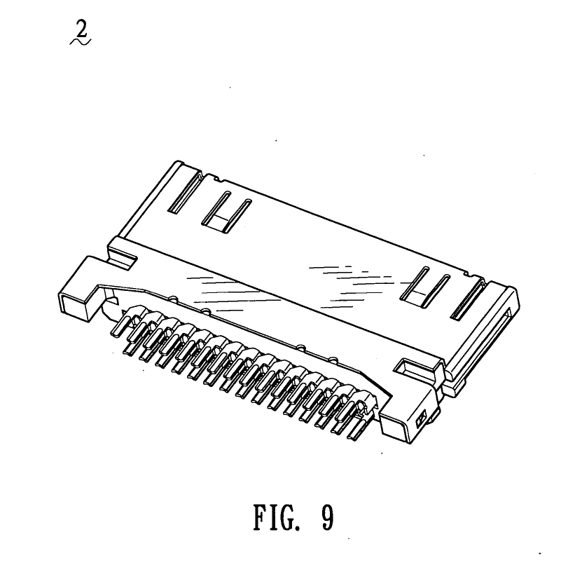

With reference to FIG. 4, the connector-positioning member 23 has three locking portions 231 for respectively engaging with the three locking bars 223 of the containing member 22 and two connector-positioning recesses 232 defined between the three locking portions 231. The sizes and the shapes of the connector-positioning recesses 232 are matched with the size and the shape of the pre-cutting connector 2 (shown in FIG. 9) so as to reliably positioning the connector 2 therein. When the connector-positioning member 23 is coupled to the front of the containing member 22, the two connector-positioning recesses 232 both open upward and respectively vertically communicate with the respective sliding grooves 222 of the containing member 22.

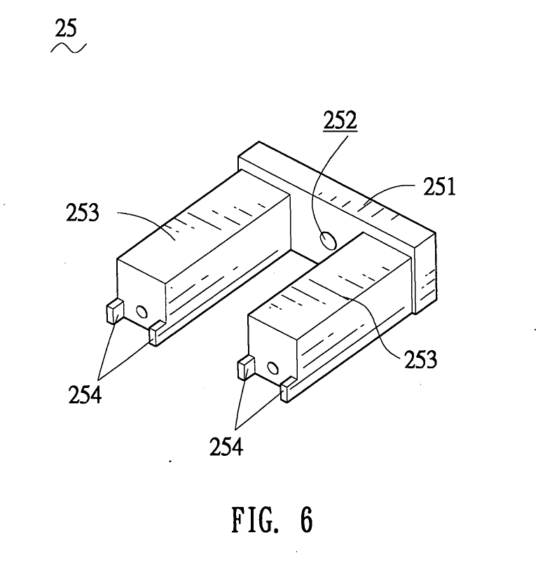

With reference to FIG. 6, the propeller 25 includes a connecting component 251 and two parallel sliding pillars 253 extending forward from the connecting component 251. The two sliding pillars 253 can be respectively slidably contained in the two sliding grooves 222 of the containing member 22. The front end of each sliding pillar 253 provides a retainer 254 for retaining the cutting member 27 on the sliding pillar 253. An assembling hole 252 is further defined in the connecting component 251 for connecting with the driving member 24.

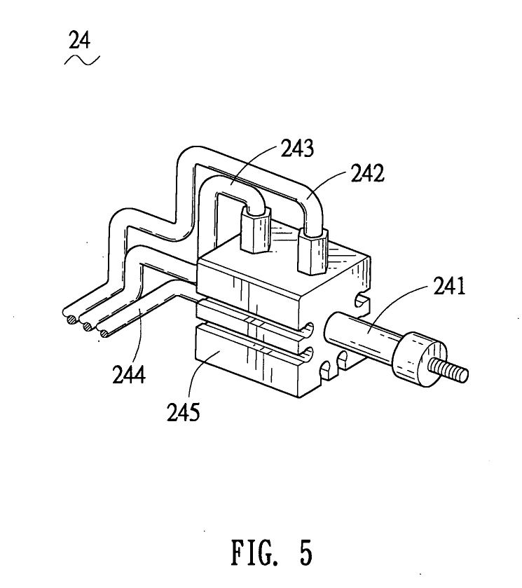

With reference to FIG. 5, the driving member 24 is an air pressure driving device, which includes an air cylinder 245, a front air-entry pipe 242, a rear air-entry pipe 243, and an exhaust pipe 244 respectively connected with the air cylinder 245. The driving member 24 further includes a driving shaft 241 having one end thereof disposed in the air cylinder 245 and the other end thereof connected with the assembling hole 252 of the propeller 25. These air pipes 242, 243, 244 further connect with the relay device 11 and are controlled by the relay device 11 to feed pressure air to the air cylinder 245 or exhaust the existing air in the air cylinder 245.

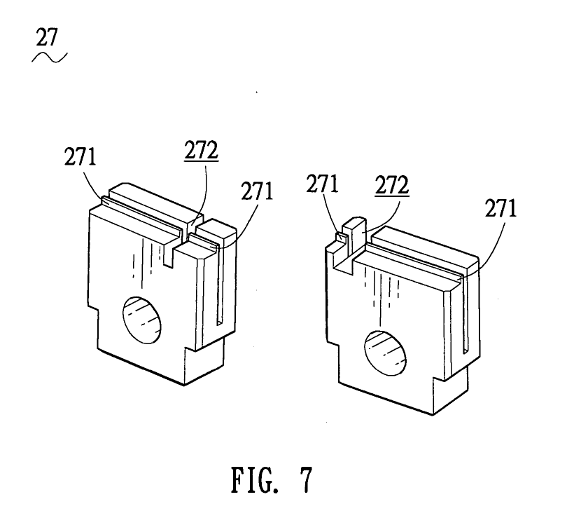

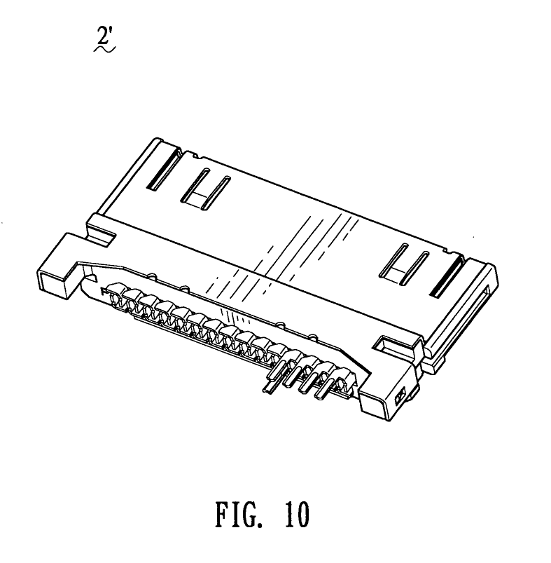

Please refer to FIG. 7 in conjunction with FIG. 9 and FIG. 10, two cutting members 27 are illustrated, each of which has cutting portions 271 and slots 272 defined between the cutting portions 271. The arrangement of the cutting portions 271 and the arrangement of the slots 272 of one of the cutting members 27 are respectively matched with the arrangement of the soldering portions of the idle pins and the arrangement of the soldering portions of the functional pins of one row of pins of the connector 2. The arrangement of the cutting portions 271 and the arrangement of the slots 272 of the other of the cutting members 27 are respectively matched with the arrangement of the soldering portions of the idle pins and the arrangement of the soldering portions of the functional pins of the other row of pins of the connector 2. The two cutting members 27 are respectively installed on the retainers 254 at the front ends of the two sliding pillars 253, so as to move together with the propeller 25 in the sliding grooves 222.

In present invention, according to one manually manipulating to the switch 14, the connector pins cutting machine 1 will perform one processing procedure. One processing procedure will be described in detail as following: firstly, the relay device 11 activates the rear air-entry pipe 243 to feed the high pressure air into the air cylinder 245 and the exhaust pipe 244 simultaneously to exhaust the existing air in the air cylinder 245, thereby driving the driving shaft 241 to move forward; next the relay device 11 activates the front air-entry pipe 242 to feed the high pressure air into the air cylinder 245 and the exhaust pipe 244 simultaneously to exhaust the existing air in the air cylinder 245, thereby driving the driving shaft 241 to move rearward. It can be seen that, one processing procedure of the connector pins cutting machine 1 corresponds to one reciprocating motion of the driving shaft 241. Furthermore, corresponding to the reciprocating motion of the driving shaft 241, the propeller 25 together with the cutting members 27 installed thereon simultaneously reciprocates in the sliding grooves 222. When the cutting members 27 move forward to a predetermined position, the soldering portions of the idle pins are cut off by the cutting portions 271 of the cutting members 27, and the soldering portions of the functional connector pins remain in the slots 272 of the cutting members 27.

Now please refer to FIGS. 8-10. As using, for example, the pre-cutting connector 2 is firstly inserted into one of the connector-positioning recesses 232 with the frame of the connector 2 being supported on the connector-positioning member 23 and the soldering portions of the connector 2 pins extending into the according sliding groove 222. Then, the switch 14 is manually operated once, one processing procedure is performed; correspondingly, one row of pins of the connector 2 is cut. Thereafter, because the connector 2 has two rows of pins, the connector 2 is taken out from the prior connector-positioning recess and inserted into the other connector-positioning recess for processing the other row of pins. Finally, after two cutting processing, the connector 2 becomes an intended connector 2′ shown in FIG. 10.

As described above, one advantage of the present invention is that, the two connector-positioning recesses 232 defined in the connector positioning member 23 can reliably position the connector 2 therein. Additionally, the propeller 25 with the cutting members 27 installed thereon is contained in the sliding grooves 222. Therefore, after the connector pins cutting machine 1 being completely assembled, the scope of operation of the cutting members 27 is restrained. That is the cutting force acted on the pins and the cutting dimensions of the pins are predetermined and constant, thereby raising the qualified rate of the connectors.

Another advantage of the present invention is that, the connector pins cutting machine 1 is driven by air pressure driving member 24, thereby less manual labor is needed, and furthermore, more connector-positioning recesses, more cutting members, more sliding grooves and more pillars can be provided in one of this type connector pins cutting machine so as to simultaneously process more connectors. That is, this type of connector pins cutting machine of present invention is consequently applied in mass productions of the connectors.

Although a preferred embodiment of the present invention has been described in detail hereinabove, it should be clearly understood that many variations and/or modifications of the basic inventive concepts herein taught which may appear to those skilled in the present art will fall within the spirit and scope of the present invention, as defined in the appended claims.

What is claimed is:

1. A connector pins cutting machine for cutting soldering portions of idle pins of a connector, comprising:
a base member;
a containing member mounted on the base member, the containing member having at least one sliding groove extending there-through;
a connector-positioning member coupled to the containing member, the connector-positioning member having at least one connector-positioning recess opening upward and communicating with said sliding groove for positioning said connector with said soldering portions of the idle pins extending into said sliding groove;
a propeller slidably contained in said sliding groove;
a cutting member installed on a front end of the propeller; and
a driving member fixed to a rear end of the propeller for driving the propeller together with the cutting member to reciprocate in the sliding groove, whereby said soldering portions are cut.

2. The connector pins cutting machine as claimed in claim 1, wherein said propeller includes a connecting component and at least one sliding pillar extending forward from the connecting component.

3. The connector pins cutting machine as claimed in claim 1, wherein a front end of said sliding pillar provides a retainer for retaining said cutting member.

4. The connector pins cutting machine as claimed in claim 2, wherein said driving member is an air pressure driving device, which includes an air cylinder, a front air-entry pipe, a rear air-entry pipe, and an exhaust pipe respectively connected with the air cylinder, and a driving shaft having one end thereof disposed in the air cylinder and the other end thereof connected with the connecting component of the propeller.

5. The connector pins cutting machine as claimed in claim 4, further including a power supply system connected with the front air-entry pipe, the rear air-entry pipe and the exhaust pipe of the driving member for supplying power to the driving member.

6. The connector pins cutting machine as claimed in claim 1, wherein said cutting member has cutting portions and slots defined between the cutting portions.
